(19) United States
(12) Patent Application Publication
(10) Pub. No.: US 2009/0048031 A1
(43) Pub. Date: Feb. 19, 2009

(54) Heat-Resistant Drive Shaft Damper Having Improved Dampening Performance

(75) Inventors: Gary A. Conger, Hemlock, MI (US); Peter T. Tkacik, Fort Mill, SC (US); Martin H. Stark, Saginaw, MI (US)

Correspondence Address: SUMMA, ADDITON & ASHE, P.A., 11610 NORTH COMMUNITY HOUSE ROAD, SUITE 200, CHARLOTTE, NC, 28277, US

(73) Assignee: CARAUSTAR INDUSTRIES, INC., Austell, GA (US)

(21) Appl. No.: 12/256,553

(22) Filed: Oct. 23, 2008

Related U.S. Application Data
(63) Continuation of application No. PCT/US2007/072529, filed on Jun. 29, 2007.
(60) Provisional application No. 60/806,379, filed on Jun. 30, 2006.

(51) Int. Cl. F16F 7/108; B21C 37/30

(52) U.S. Cl. 464/180; 72/370.25

(57) ABSTRACT

The invention is a heat-resistant drive shaft damper adapted to be inserted into a hollow automotive drive shaft. The damper with improved heat-resistant and NVH-reduction properties includes a retaining member that extends above the damper's outside surface and possesses a maximum operating temperature of 175° C. or higher. The invention further relates to a method of forming such a damper.

### CROSS-REFERENCE TO PRIORITY APPLICATION

This application is a continuation of commonly assigned International Patent Application No. PCT/US07/72529 for Heat-Resistant Drive Shaft Damper Having Improved Dampening Performance, filed Jun. 29, 2007 (and published Jan. 10, 2008, as Publication No. WO 2008/005863 A2), which itself claims the benefit of commonly assigned U.S. Provisional Patent Application Ser. No. 60/806,379, for Heat-Resistant Drive Shaft Damper, filed Jun. 30, 2006. This nonprovisional application claims the benefit of and incorporates entirely by reference both this international application and this U.S. provisional patent application.

### FIELD OF THE INVENTION

The invention relates to a heat-resistant drive shaft damper adapted for use in a hollow automotive drive shaft to dampen vibrations and attenuate sound in vehicles, such as cars, trucks, tractors, and heavy machinery. The invention further relates to methods of forming and using such drive shaft dampers.

### BACKGROUND OF THE INVENTION

An automobile conventionally employs a hollow, tubular drive shaft to transmit torque from the transmission to the differential gears. Such drive shafts, however, often produce annoying NVH (i.e., noise, vibration, and harshness). Accordingly, it is desirable to dampen NVH to provide for a quieter and smoother ride. Furthermore, it is desirable to prevent vibration to avoid mechanical failure from the loosening of assembled vehicle parts.

Several commonly assigned patents address NVH reduction. For example, U.S. Pat. No. 4,909,361 to Stark et al. discloses a drive shaft damper having a base tube or core formed of helically wound paper. A helical retaining strip, such as ethylene propylene diene monomer rubber (i.e., EPDM) is fixed to the core to engage the bore of the drive shaft.

Another example is U.S. Pat. No. 5,976,021 to Stark et al. U.S. Pat. No. 5,976,021 improves the drive shaft damper disclosed in U.S. Pat. No. 4,909,361 by including sealed ends and an innermost layer of waterproof material, such as aluminum foil.

Yet another example is U.S. Pat. No. 5,924,531 to Stark et al. U.S. Pat. No. 5,924,531 discloses a vibration damping shaft liner having a cylindrical core and a corrugated layer wound around the core in alternating helical grooves and flutes.

Each of the above-referenced patents is herein incorporated by reference in its entirety.

The drive shaft dampers disclosed in the foregoing, commonly assigned patents are well suited for their intended purposes. That notwithstanding, ever more manufacturers are producing drive shafts having standardized end diameters. Such drive shafts accommodate universal joint flanges, which attach the drive shaft to the gearboxes and differentials in motor vehicles. This standardization is achieved by reducing the diameter at the respective drive shaft ends, a process referred to as “swaging.”

The reduction of the drive shaft ends necessitates the insertion of the damper into the drive shaft prior to the swaging process. Thereafter, the drive shaft is heat treated under extreme conditions (e.g., 350° F.) for a period sufficient to strengthen the drive shaft (e.g., about 6-8 hours).

Accordingly, there is a need for drive shaft dampers that can withstand the extreme heat-treatment conditions required for modern drive shaft manufacturing. In particular, there is a need for drive shaft dampers that can be inserted into drive shafts before swaging.

### SUMMARY OF THE INVENTION

It is an object of the present invention to provide a drive shaft damper that can withstand extreme conditions (e.g., high temperatures) during the heat-aging and strengthening processes.

It is yet a further object of the present invention to provide a drive shaft damper that minimizes NVH.

It is yet a further object of the present invention to provide a drive shaft damper that possesses greater resistance to corrosive chemicals that may be encountered during the manufacturing of swaged drive shafts.

It is yet a further object of the present invention to provide a drive shaft damper that has improved resistance to in-use deterioration (i.e., while installed and used in a vehicle).

It is yet a further object of the present invention to provide a drive shaft damper that, once positioned, stays fixed within the drive shaft.

It is yet a further object of the present invention to provide a dampened hollow drive shaft that includes a hollow drive shaft and a convolute or spirally wound damper secured within the drive shaft.

The foregoing, as well as other objectives and advantages of the invention and the manner in which the same are accomplished, is further specified within the following detailed description and its accompanying drawings.

### BRIEF DESCRIPTION OF THE DRAWINGS

FIG. 1 depicts an exemplary drive shaft damper having a spirally wound retaining member.

FIG. 2 depicts a section of an exemplary drive shaft damper.

FIG. 3 depicts an exemplary drive shaft damper having a circumferentially positioned retaining member.

FIG. 4 depicts an exemplary drive shaft damper having an axially positioned retaining member.

FIGS. 5a-5g depict exemplary retaining member structures.

FIG. 6 illustrates the superior performance of dampers that include silicone-containing retaining members.

### DETAILED DESCRIPTION

The invention embraces tubular drive shaft dampers having improved heat resistance and NVH-reduction properties.

In one aspect, the invention is an improved drive shaft damper formed of a substantially cylindrical structure, such as a convolute tube or, more typically, a spirally wound tube. The substantially cylindrical structure itself is typically formed of fibrous material, such as paper or other polymeric material.

In another aspect, the invention is a method of making dampers with improved heat-resistance and NVH-reduction properties. Typically, this includes inserting the improved damper into a tubular drive shaft, then swaging the ends of the drive shaft by rolling the ends under high radial pressure using shaped rollers (i.e., roll swaging).

Thereafter, the drive shaft is heated to a temperature of 350° F. for a period sufficient to increase its strength and wear (e.g., between about 4 to 12 hours).

In another aspect, the invention is a dampened tubular drive shaft with swaged ends. The dampened tubular drive shaft includes the improved drive shaft damper according to the foregoing description. A portion of the tubular drive shaft may possess a substantially fixed inner diameter between its swaged ends, thereby providing space for the present damper to be positioned (i.e., within the drive shaft's substantially fixed inner diameter). This dampened drive shaft is typically formed of metal (e.g., aluminum).

In yet another aspect, the invention embraces a vehicle that includes this kind of dampened drive shaft.

The substantially cylindrical structure of the drive shaft damper is typically made up of one or more spirally wound plies. These plies may be configured to form butt joints, overlap joints, and/or seam gap joints. The spirally wound plies may also include one or more moisture-resistant layers. In addition, the spirally wound plies may include one or more adhesive layers positioned between adjacent plies so that adjacent plies are affixed to one another.

FIG. 1 depicts an exemplary drive shaft damper 10 positioned within a tubular drive shaft 100 having an inside surface 101 and an outside surface 102. The drive shaft damper 10 is partly characterized by its substantially cylindrical structure 11. Thus, the outside surface of the substantially cylindrical structure 11 is positioned adjacent to the inside surface 101 of the drive shaft 100.

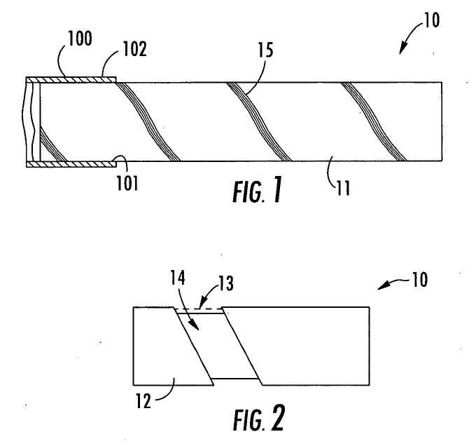

In this exemplary embodiment, the substantially cylindrical structure 11 of the drive shaft damper 10 is formed by several layers of spirally wound plies 12. See FIG. 2. Adjacent spirally wound plies may be bound together by respective adhesive layers 13. That is, an adhesive layer 13 is positioned between adjacent spirally wound plies 12.

FIG. 2 depicts an outermost spirally wound ply 12 forming a seam gap joint 14 formed along the entire length of the substantially cylindrical structure 11. In this configuration, a retaining member 15 is positioned between the spiral seam gap joint 14 formed by the outermost spirally wound ply 12. A portion of the retaining member 15 is positioned beneath the outermost spirally wound ply 12. Those having ordinary skill in the art will appreciate that the seam gap joint 14 may be formed by one or more spirally wound plies 12.

Although the retaining member 15 is typically positioned between a seam gap joint 14 of the substantially cylindrical structure 11 (i.e., a spirally wound tube), the retaining member 15 can simply be affixed to the outside surface of the substantially cylindrical structure 11. In such embodiments, the substantially cylindrical structure 11 can be, for example, a spirally wound tube, a convolute tube (e.g., using one or more convolute plies), or an extruded tube.

In one such embodiment, the retaining member 15 is spirally wound around the substantially cylindrical structure 11, typically along the entire length of the substantially cylindrical structure 11. See FIG. 1.

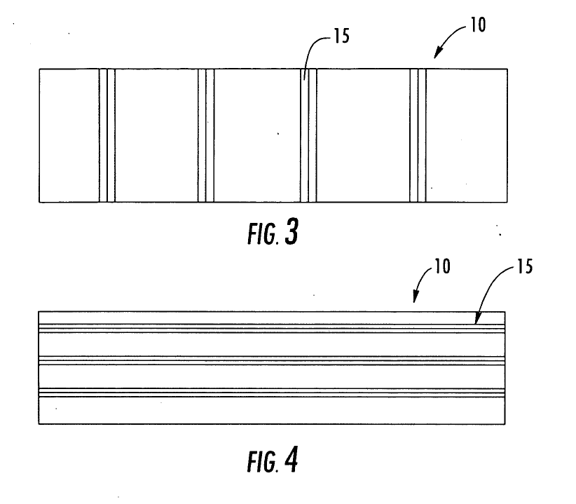

In another such embodiment, the retaining member 15 is circumferentially positioned about the substantially cylindrical structure 11. See FIG. 3.

In yet another such embodiment, the retaining member 15 is positioned parallel to the axis of the substantially cylindrical structure 11. See FIG. 4.

In any of these foregoing configurations, the retaining member 15 is typically secured (e.g., bonded) to the substantially cylindrical structure 11 using adhesive to ensure durability during drive shaft manufacture and subsequent use.

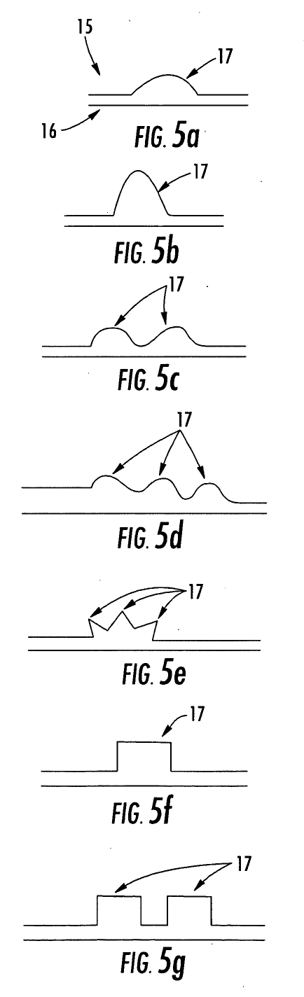

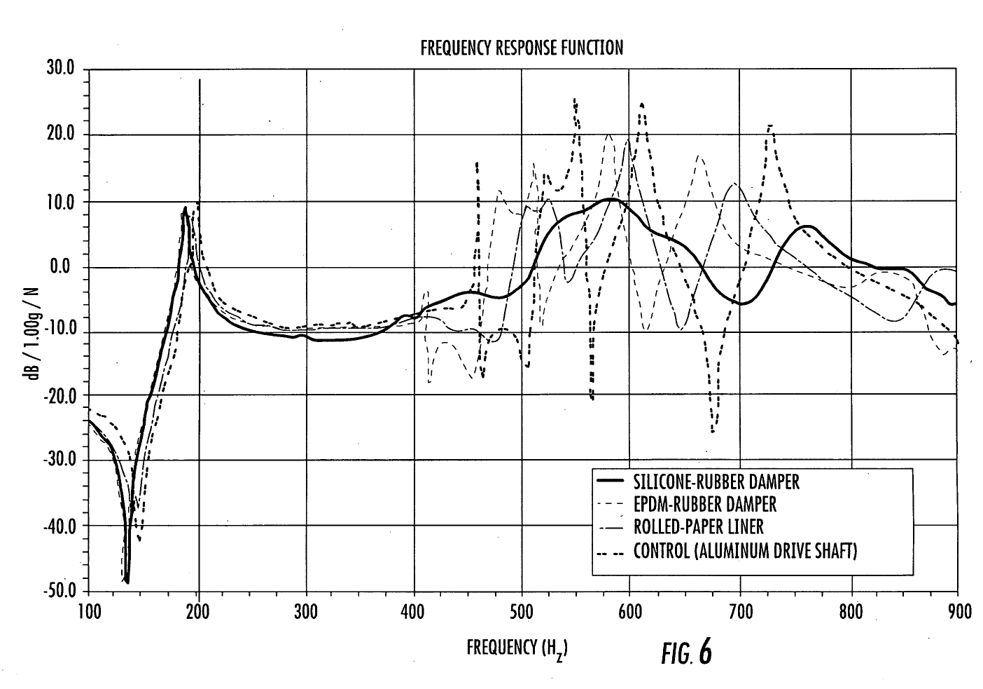

As noted, FIGS. 5a-5g depict possible retaining member structures (e.g., a ridge, bump, nub, rib or a spike). The retaining member 15 has a base 16 and at least one protuberance 17. When the retaining member 15 is positioned on the substantially cylindrical structure 11, the protuberance or protuberances 17 extend beyond the outside surface of the substantially cylindrical structure 11. In this regard, at least one protuberance 17 extends about 0.2 inch or more (e.g., between about 0.245 and 0.255 inch) above the outside surface of the substantially cylindrical structure 11.

Thus, the retaining member 15 extends above the outermost surface of the substantially cylindrical structure 11 in the form of a protuberance 17. See FIGS. 5a-5g. This ensures that the drive shaft damper 10 is capable of being frictionally positioned within the inner annular space of the tubular drive shaft 100.

In other words, the maximum radius of the drive shaft damper 10 is defined by the highest protuberance 17 of the retaining member 15. Moreover, the maximum radius of the drive shaft damper 10 is greater than the radius defined by the internal annular space of the tubular drive shaft 100. As depicted in FIG. 1, the radius defined by this internal annular space refers, for example, to that part of the tubular drive shaft 100 that possesses a substantially fixed inner diameter (i.e., between the swaged ends). In this way, the drive shaft damper 10, once positioned within the drive shaft 100, stays frictionally secured.

In one embodiment of the drive shaft damper, the substantially cylindrical structure includes an outermost layer of corrugated paper or paperboard. In another embodiment, the substantially cylindrical structure includes an outermost layer of (non-corrugated) paperboard (i.e., having a smooth surface). Surprisingly, a drive shaft damper configuration in which the outermost layer is formed of smooth-surface paperboard seems to have better noise attenuation as compared with a configuration in which the outermost layer is formed of corrugated paperboard.

Table 1 (below) compares power spectrum data for dampers having various constructions (e.g., dampers having three-rib rubber retaining members and/or single faced corrugated surface layers).

Those having ordinary skill in the art will appreciate that noise levels are measured in decibels (dB), and that a better damper will have greater decibel reduction. (Zero dB is typically established as the limit of human hearing in the most sensitive frequency ranges.)

TABLE 1

| | | | | Drive Shaft |
|---|---|---|---|---|
| Plot | Level | Reduction | Frequency | Configuration |
| 1 | −13 dB | — | 815 Hz | no damper |
| | | | | (comparative example) |
| 2 | −44 dB | −31 dB | 942 Hz | corrugated damper w/ |
| | | | | 3-rib rubber |
| 3 | −64 dB | −51 dB | 1475 Hz | smooth-surface damper |
| | | | | w/3-rib rubber |
| 4 | −58 dB | −45 dB | 905 Hz | damper w/two 3-rib |
| | | | | rubber |
| 5 | −42 dB | −29 dB | 942 Hz | welded on yokes w/ |
| | | | | damper w/single 3- |
| | | | | rib rubber |
| 6 | −27 dB | −14 dB | 960 Hz | damper w/corrugated |
| | | | | w/o rubber |

Table 1 suggests that the smooth-surface damper with a three-rib retainer member performs best at NVH reduction (i.e., this damper achieved the greatest decibel reduction).

As noted, the drive shaft damper according to the present invention is typically inserted into a tubular drive shaft before the drive shaft is swaged and thereafter subjected to heat treatment and aging. To endure the extreme heat-treatment conditions required for modern drive shaft manufacturing, the retaining member must be heat resistant. In particular, the heat-resistant retaining member must be able to endure an operating temperature of about 175° C. or more (i.e., greater than about 347° F.). Those having ordinary skill in the art will appreciate that 175° C. is above the serviceable temperature of EPDM and natural rubber. See R. A. Higgins, Properties of Engineering Materials, 2^{nd} ed. Industrial Press Inc., 1994, p. 314.

For some applications, the heat-resistant retaining member will possess a maximum serviceable temperature (i.e., maximum operating temperature) greater than about 190° C. (i.e., greater than about 375° F.), typically greater than 200° C. (i.e., greater than about 390° F.), such as 205° C. (i.e., greater than about 400° F.). In other words, as used herein, the term “operating temperature” refers to those temperatures in which the heat-resistant retaining member continues to maintain its structural integrity and effectively reduces NVH as part of the drive shaft damper.

For some extreme heat applications, the heat-resistant retaining member will possess a maximum serviceable temperature greater than about 250° C. (i.e., greater than about 480° F.), typically greater than 275° C. (i.e., greater than about 525° F.), such as 285° C. (i.e., greater than about 545° F.).

Silicone-containing polymeric material is particularly suitable for a heat-resistant retaining member. In this regard, silicone-containing polymeric material is serviceable up to at least 285° C.

In addition, heat-resistant retaining members formed from silicone-containing polymeric material have been observed to possess enhanced dampening characteristics. This is unexpected.

In this regard, FIG. 6 depicts the performance of three drive shaft dampers possessing smooth paper surfaces. In particular, FIG. 6 compares various frequency response functions (energy versus frequency) for a 78-inch aluminum drive shaft (i.e., prop shaft). The undampened aluminum drive shaft (i.e., the control) showed undesirable frequency response as indicated by the frequent spikes. The same kind of aluminum drive shaft showed better frequency response (i.e., dampening ratio) when dampened using either (i) one 59 inch rolled paper liner (i.e., a convolute tube) or (ii) two 29-inch EPDM-modified dampers (i.e., modified with an EPDM rubber retaining member).

That said, the same kind of aluminum drive shaft showed far better frequency response when dampened using two 29-inch silicone-modified dampers according to the present invention (i.e., modified with a silicone rubber retaining member). Upon examination of FIG. 6, those having ordinary skill in the art will recognize that the frequency response of the drive shaft damper with a silicone rubber retaining member is remarkably smooth (i.e., dampened). This demonstrates the superior dampening performance (i.e., dampening ratio) of drive shaft dampers according to the present invention.

A heat-resistant retaining member formed from silicone rubber is capable of withstanding not only extremely high temperatures (e.g., 350° F. or more) but also extremely cold temperatures (e.g., −60° F. or less). Accordingly, a silicone-containing retaining member possesses a broad operating temperature range.

In forming the heat-resistant retaining member, silicone-containing polymeric material, such as silicone rubber, may be employed alone or with other materials. A silicone rubber that is suitable for forming heat-resistant retaining members is available from Timco Rubber Products, Inc. as 50 DUROMETER SILICONE. See Table 2 (below):

TABLE 2
(50 DUROMETER SILICONE)

| | Typical | ASTM Test |
|---|---|---|
| General Purpose Properties | Value | Method |
| Hardness (Shore A) | 50 | D 2240 |
| Compression set | 20 | D 395 |
| (22 h @ 100° C., max %) | | |
| Ozone resistance | No cracks | D 1149 |
| (100 MPa, 100 h @ 40° C., | | |
| 20% elongation) | | |
| Tensile strength (psi) | 725 | D 412 Die C |
| Elongation @ rupture (min, %) | 300 | D412 Die c |
| Heat aging (70 h @ 100 C.): | | |
| Hardness increase, (max. duro. | +5 | D 573 |
| points) | | |
| Change in tensile strength, | −15 | D 573 |
| (max %) | | |
| Change in elongation, max % | −21 | D 573 |
| Tear strength (min. kN/m | (136) | D624 Die B |
| (lb_{f}/in)) | | |

In the specification and drawings, typical embodiments of the invention have been disclosed and, although specific terms have been employed, they have been used in a generic and descriptive sense only and not for purposes of limitation.

1. A drive shaft damper possessing improved heat-resistance and NVH-reduction properties, comprising:
a substantially cylindrical structure defining an inside surface and an outside surface; and
a heat-resistant retaining member secured to said outside surface of said substantially cylindrical structure, said heat-resistant retaining member possessing maximum operating temperature of at least about 350° F.;
wherein said heat-resistant retaining member extends above said outside surface of said substantially cylindrical structure.

2. A drive shaft damper according to claim 1, wherein said retaining member possesses a maximum operating temperature of at least about 375° F.

3. A drive shaft damper according to claim 1, wherein said retaining member possesses a maximum operating temperature of at least about 400° F.

4. A drive shaft damper according to claim 1, wherein said retaining member possesses a maximum operating temperature of at least about 425° F.

5. A drive shaft damper according to claim 1, wherein said retaining member possesses a maximum operating temperature of at least about 450° F.

6. A drive shaft damper according to claim 1, wherein said retaining member possesses a maximum operating temperature of at least about 500° F.

7. A drive shaft damper according to claim 1, wherein said substantially cylindrical structure comprises a spirally wound tube.

8. A drive shaft damper according to claim 1, wherein said substantially cylindrical structure comprises one or more spirally wound plies.

9. A drive shaft damper according to claim 8, wherein said spirally wound plies form butt joints.

10. A drive shaft damper according to claim 8, wherein said spirally wound plies form overlap joints.

11. A drive shaft damper according to claim 8, wherein said spirally wound plies form seam gap joints.

12. A drive shaft damper according to claim 11, wherein part of said retaining member is positioned between said seam gap joints and another part of retaining member is positioned underneath said seam gap joints.

13. A drive shaft damper according to claim 1, wherein said substantially cylindrical structure comprises a convolute tube.

14. A drive shaft damper according to claim 1, wherein said retaining member, comprises:
a base that is secured to said substantially cylindrical structure; and
at least one protuberance that extends above said outside surface of said substantially cylindrical structure.

15. A drive shaft damper according to claim 14, wherein said protuberance extends above said outside surface of said substantially cylindrical structure by at least about 0.2 inch.

16. A drive shaft damper according to claim 1, wherein the retaining member is spirally wound around said substantially cylindrical structure.

17. A drive shaft damper according to claim 1, wherein the retaining member is spirally wound along the length of said substantially cylindrical structure.

18. A drive shaft damper according to claim 1, wherein at least one retaining member is positioned substantially parallel to the axis of said substantially cylindrical structure.

19. A drive shaft damper according to claim 1, wherein at least one retaining member is circumferentially positioned about said substantially cylindrical structure.

20. A drive shaft damper according to claim 1, wherein said drive shaft damper provides improved dampening ratio as compared with an otherwise identical damper having an EPDM-rubber retaining member.

21. A drive shaft damper according to claim 1, wherein said substantially cylindrical structure comprises a substantially cylindrical fibrous structure.

22. A drive shaft damper according to claim 1, wherein said substantially cylindrical structure comprises a substantially cylindrical paperboard structure.

23. A drive shaft damper according to claim 1, wherein said substantially cylindrical structure comprises substantially smooth paperboard that defines said outside surface of said substantially cylindrical structure.

24. A drive shaft damper according to claim 23, wherein said drive shaft damper provides improved dampening ratio as compared with an otherwise identical damper having an EPDM-rubber retaining member.

25. A drive shaft damper according to claim 23, wherein said drive shaft damper provides improved dampening ratio as compared with an otherwise identical comparative damper having a corrugated paperboard ply that defines the comparative damper's outside surface.

26. A drive shaft damper according to claim 23, wherein said drive shaft damper provides improved dampening ratio as compared with an otherwise identical comparative damper having (i) a corrugated paperboard ply that defines the comparative damper's outside surface and (ii) an EPDM-rubber retaining member.

27. A drive shaft damper according to claim 1, wherein said substantially cylindrical structure comprises at least one single-faced corrugated paperboard ply.

28. A drive shaft damper according to claim 27, wherein said substantially cylindrical structure comprises a paperboard tube whose outside surface is formed by said single-faced corrugated paperboard ply.

29. A drive shaft damper according to claim 1, wherein said substantially cylindrical structure comprises polymeric material.

30. A drive shaft damper according to claim 1, wherein said substantially cylindrical structure comprises moisture-resistant material.

31. A drive shaft damper according to claim 1, wherein the retaining member comprises silicone-containing polymeric material.

32. A drive shaft damper according to claim 1, wherein the retaining member consists essentially of silicone rubber.

33. A dampened tubular drive shaft formed from the drive shaft damper according to claim 1, wherein the drive shaft damper is frictionally secured within the tubular drive shaft.

34. A vehicle comprising the dampened tubular drive shaft of claim 33.

35. A method of forming a dampened drive shaft using the drive shaft damper according to claim 1, the method comprising the following steps:
a. inserting the drive shaft damper into a tubular drive shaft;
b. thereafter, swaging the ends of the drive shaft; and
c. heating the swaged drive shaft to a temperature of at least about 350° F. for a period sufficient to increase the strength and wear properties of the drive shaft.

36. A method according to claim 35, wherein the step of heating the swaged drive shaft to increase the strength and wear properties of the drive shaft comprises heating the swaged drive shaft to a temperature of at least about 400° F. for at least six hours.

37. A method of making a dampened drive shaft having improved NVH-reduction, comprising:
providing a drive shaft damper comprising:
a substantially cylindrical structure defining an inside surface and an outside surface; and
a heat-resistant retaining member secured to said outside surface of said substantially cylindrical structure, said heat-resistant retaining member possessing maximum operating temperature of at least about 350° F.;
wherein said heat-resistant retaining member extends above said outside surface of said substantially cylindrical structure;
providing a tubular drive shaft having substantially constant inner diameter;
inserting the drive shaft damper into the portion of the tubular drive shaft having substantially constant inner diameter;
thereafter swaging at least one end of the tubular drive shaft such that the swaged end has an inner diameter that is less than the drive shaft's maximum inner diameter; and
thereafter heating the drive shaft damper and swaged tubular drive shaft to a temperature of at least about 350° F. for a period sufficient to increase the strength properties of the drive shaft.

38. A method according to claim 37, wherein the step of heating the swaged drive shaft to increase the strength properties of the drive shaft comprises heating the swaged drive shaft to a temperature of at least about 350° F. for between about six and eight hours.

39. A dampened drive shaft possessing improved NVH-reduction, comprising:
a tubular drive shaft defining an internal annular space;
a damper positioned within the tubular drive shaft, the damper comprising:
a substantially cylindrical structure defining an inside surface, an outside surface, and a central axis; and
a heat-resistant retaining member secured to said outside surface of said substantially cylindrical structure, said heat-resistant retaining member possessing an operating temperature greater than 175° C.; and
wherein said heat-resistant retaining member extends above said outside surface of said substantially cylindrical structure, thereby defining the damper's maximum radius as measured from the central axis of the substantially cylindrical structure and the outermost point of the retaining member; and
wherein the damper's maximum radius is greater than the radius of the internal annular space of said tubular drive shaft.

40. A dampened drive shaft according to claim 39, wherein said damper's heat-resistant retaining member comprises silicone-containing polymeric material.

41. A dampened drive shaft according to claim 39, wherein said damper's heat-resistant retaining member contacts the inside surface of the tubular drive shaft.

42. A dampened drive shaft a according to claim 39, wherein said damper's heat-resistant retaining member is frictionally fixed within the tubular drive shaft.

43. A dampened drive shaft according to claim 39, wherein said tubular drive shaft possesses a substantially fixed inner diameter between its swaged ends.

44. A dampened drive shaft according to claim 43, wherein said damper is positioned within the portion of the tubular drive shaft having a substantially fixed inner diameter.
